(19) United States
(12) Patent Application Publication
(10) Pub. No.: US 2004/0208202 A1
(43) Pub. Date: Oct. 21, 2004

(54) Transmission of large volumes of data via asynchronous interfaces in circuits with redundancy concept of the checker-master type

(76) Inventors: Franz Hechfellner, St Wolfgang (DE); Rainer Vetter, Munchen (DE)

Correspondence Address: Siemens Corporation, Intellectual Property Department, 170 Wood Avenue South, Iselin, NJ, 08830, US

(21) Appl. No.: 10/488,321

(22) PCT Filed: Aug. 28, 2002
(86) PCT No.: PCT/DE02/03155

(30) Foreign Application Priority Data
Aug. 31, 2001 (DE) 10142611.9

(51) Int. Cl. H04J 3/06

(52) U.S. Cl. 370/503; 370/395.4

(57) ABSTRACT

The invention concerns a method for transmitting large volumes of data via an asynchronous interface in a redundancy circuit of the checker-master type. The invention is characterized in that the data are transmitted on the basis of the type and volume of data to be transmitted, in accordance with different transmission cycles, whereof the operation is fixed and provided by means of finite state automatons (FSM) on both sides of the interface. Said FSM can control the management of the data on data buses whereof the number and size are random. On each of said buses, the data are stably maintained on the output side until they can be securely managed on the input side. Said concept enable transmission of a random number of data at every following phase until the cycle is completed.

### CROSS REFERENCE TO RELATED APPLICATIONS

This application is the US National Stage of International Application No. PCT/DE/020315, filed Aug. 28, 2002 and claims the benefit thereof. The International Application claims the benefits of German application No. 10142611.9 filed Aug. 31, 2001, both of the applications are incorporated by reference herein in their entirety.

### FIELD OF INVENTION

The subject matter of the application relates to a meted for the transfer of data via an asynchronous interface in a circuit arrangement based on master/checker redundancy.

### BACKGROUND OF INVENTION

High availability is an important feature of technical installations such as, for example, telecommunications switching systems. In order to guarantee this high availability, faults in component parts of these installations must be detected and pinpointed as quickly as possible so that the defective units can be disconnected. One concept for locating faults in hardware is based on duplication according to the master/checker principle.

In this arrangement the complete circuit unit is configured in duplicate and processes all input information in parallel in exact clock synchronism. All data leaving this unit is compared between master and checker. If discrepancies occur, the unit is taken out of service and subjected to fault diagnosis.

Special measures are necessary if, within a duplicated structure of this kind that operates in clock-controlled synchronism, signals are to be routed via asynchronous interfaces. If conventional two-stage re-timing were to be applied to all the signals on the asynchronous interface, then there is a high probability that some of the signals would be clocked into master and checker registers in different clock periods.

Irrespective of the duplex structure, wide data buses, when they are to be routed via an asynchronous interface, must not simply be clocked into the next register stage, as otherwise individual bits would be transferred into the other clock domain in different clock periods. Rather, all the data to be transferred must be kept stable on the transmitting (output) side for the duration of several clock pulses so that they can be accepted correctly on the receiving (input) side.

In this process, if the data arrives faster than it can be passed on via the interface, a means of buffering becomes necessary and the data flow must possibly even be slowed down.

The transfer of wide data buses via asynchronous interfaces can be controlled for example by means of a qualifier signal. For this purpose the data is transferred from the data bus into a register, where it is kept stable for several (3-4) clock pulses so that is can be transferred correctly into the other clock domain. When the data is ready for the transfer, the qualifier signal goes active. After a two-stage re-timing, this signal indicates in the receiver clock domain that the data can now be transferred in its full width into the other clock domain. A prerequisite for this method is that the data rate on the bus is not greater than the transmission capacity of the interface.

In the case of the clocked master/checker structure it must additionally be ensured that master and checker accept the data in the same clock pulse, as otherwise comparator errors would quickly occur. For this, there are different approaches to a solution:

Data and qualifier signal are accepted only by the master, the qualifier signal is re-timed and distributed to master and checker. The transfer of the master data to master and checker is controlled by this means. In this way part of the redundancy is of course lost, since it involves a temporary departure from the duplication principle. This can be partially compensated by means of additional measures:

At the point of transition to the nonduplicated transmission path, errors which have occurred up to that time can be detected by a comparison of the master and checker data;

the data on the non-duplicated transmission path can be protected for example by parity checking.

Prior methods for data transmission via asynchronous interfaces were based on the flow control principle. Since the data has to be kept stable at the interface for several clock pulses to ensure that it can be transferred correctly into the other clock domain, comparatively large volumes of data have to be buffered and if necessary the data flow slowed down if it threatens to exceed the transmission capacity of the interface.

### SUMMARY OF INVENTION

The object of the subject matter of the application is to specify a means of transferring even large volumes of data via an asynchronous interface while retaining a maximum of the master/checker redundancy.

The object is achieved with the subject matter outlined at the beginning by the features recited in claim 1.

The subject matter of the application permits fast and efficient transfer even of large volumes of data via asynchronous interfaces while retaining a maximum of the master/checker redundancy.

A reduction in the data flow is not necessary with the subject matter of the application. At the same time this concept is ideally suited to a master/checker redundancy structure. In both clock domains the Finite State Machines (FSMs) in master and checker each run in clock-controlled synchronism; only the activation of the transmission cycle needs to be synchronized and performed centrally on master and checker. Thereafter, both halves accept only the data of their partner half in each case, thereby ensuring that the redundancy concept remains intact virtually from end to end.

Advantageous developments of the subject matter of the application are specified in the subclaims.

### BRIEF DESCRIPTION OF THE DRAWINGS

The subject matter of the application will be explained below as an exemplary embodiment to an extent necessary for understanding and with reference to figures, in which:

FIG. 1 shows a parallel data transfer via an asynchronous interface in a circuit according to the master/checker redundancy principle, and

FIG. 2 shows a timing diagram of the cycle-oriented transfer via an asynchronous interface.

In the figures the same designations are used to identify identical elements.

### DETAILED DESCRIPTION OF INVENTION

The concept underlying the subject matter of the application may be referred to as “cycle-oriented transmission”.

Let the following be assumed as prerequisites:

The data to be transferred arrives at the interface in the form of discrete portions, not as a continuous data stream. The start and end of a data portion to be transferred are clearly defined.

The data portions to be transferred can be classified; that is, assigned to specific cycle types and/or formats (cells, packets). Each of these cycles runs in a fixed timing pattern. The number of cycle types/formats is finite. Different types of transmission cycles can basically run independently of one another in parallel.

Examples of this are processor write or read cycles with address, control signals and where applicable write data in a fixed timing pattern; packet formats such as ATM cells, IP packets, or even an individually chosen format for parallel transmission of status information etc. in one or more succeeding clock pulses.

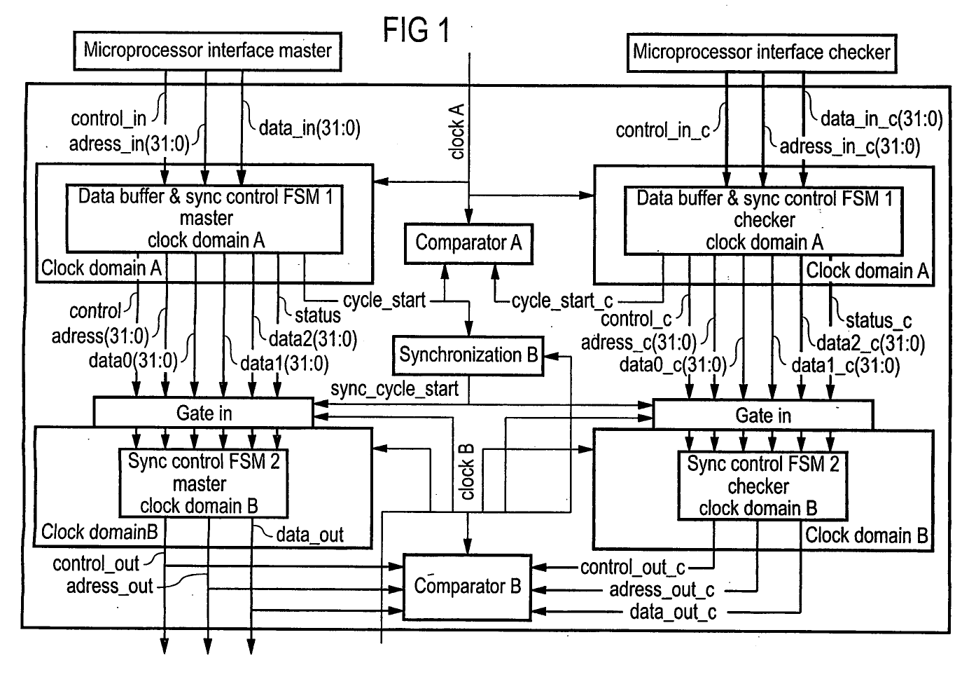

Sequence (see FIG. 1):

The transmission of the data from one clock domain to the other is performed via one or more data buses of arbitrary width separately from master to master and from checker to checker in each case. There is no restriction of the redundancy while this takes place.

For each cycle type occurring, the start and end of the transmission of a data portion are permanently defined and the sequence takes place in a fixed timing pattern. Thus, the transmission can be handled either in the transmitting clock domain (in this case clock domain A) or in the receiving clock domain (clock domain B) by means of a Finite State Machine (FSM). The FSM in the transmitting clock domain signals the start and type of the transmission cycle, while the further sequence follows a predetermined scheme in both FSMs.

Master and checker provide the first data to be transferred in the same clock pulse (clock domain A) at the asynchronous interface. As soon as the data is stable, the sync control FSM1 in master and checker indicate the start of the transmission cycle in synchronism (cycle_start signal). The data is kept stable until it has been correctly accepted in the receiving clock domain (sync control FSM2, clock domain B). If the asynchronous interface resides within a module, 3 to 4 clock pulses are sufficient here; otherwise, longer times are required depending on line lengths.

The cycle_start signal is the only point in this concept at which it is necessary to depart from the master/checker redundancy concept. Only the signal from the master unit will be synchronized by multi-stage re-timing in the receiving clock domain (Synchronization B-clock domain B) and starts as sync_cycle_start, then again in clock-controlled synchronism in master and checker, the sync control FSM2 for data transfer into clock domain B. Prior to the synchronization of the master signal, the cycle_start signals of master and checker which are present in duplicate are compared.

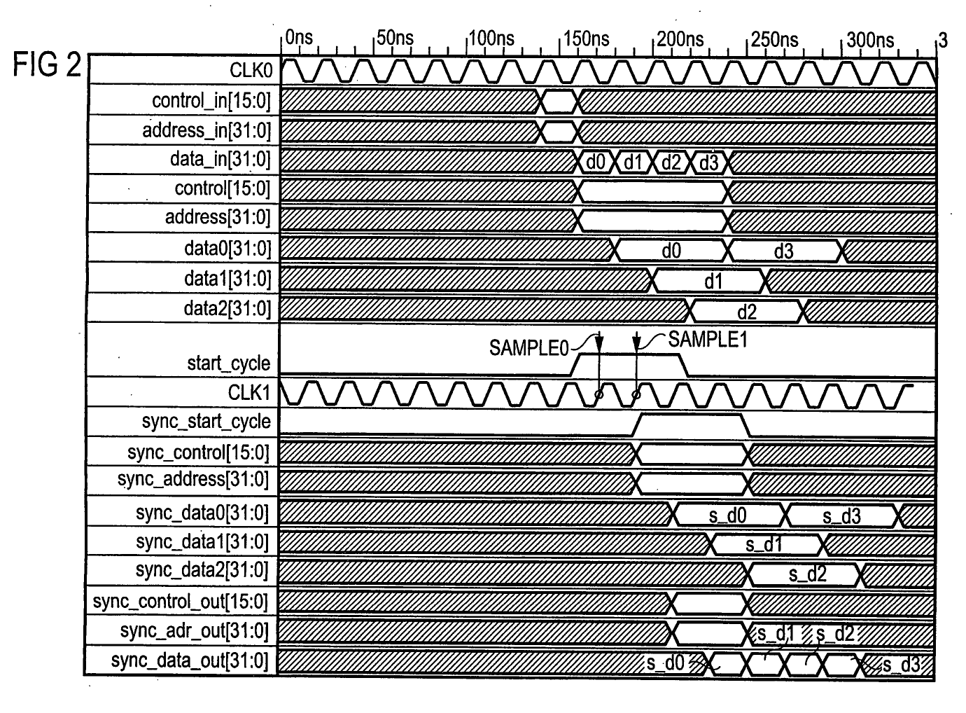

The time sequence is represented schematically in FIG. 2 as a timing diagram.

Advantages of this concept:

Limiting the transmission to a specified number of predefined cycle types/formats enables also large volumes of data which arrive in close succession for this purpose at the interface to be transferred quickly and efficiently via asynchronous interfaces. If the data is received faster than it can be transferred via the interface, it is buffered on the transmitting (output) side and possibly transferred in parallel. The FSM can also control the parallel transfer of data on a plurality of data buses.

Since the entire transmission is controlled in precise synchronism by Finite State Machines both on the transmitting (output) and on the receiving (input) side, only the start of the transmission has to be signaled synchronously and centrally for master and checker. The cycle type can then be reported together with the first control signals.

The master/checker redundancy concept is breached only at a single point, but here an additional safeguard is provided by comparison.

The example in FIG. 1 shows the handling of write cycles in a system comprising 2 microprocessors in a master/checker redundancy configuration in clock domain A to a storage unit (buffer) in clock domain B. The latter is supplied with a separate clock, since it is shared by a plurality of processors.

The different write cycles which the processors handle to the buffer, differ in terms of data word lengths: write byte (1 byte, 2 bytes, 3 bytes), word (=4 * byte), burst (=4 * word). All cycles start with the assertion of the 32-bit address and the control signals (clock 1). Differences arise in the occupancy of the 32-bit data bus: in write cycles, write data can be placed on the data bus in multiple succeeding clock pulses (e.g. 4 clock pulses for write burst, =clock pulses 2-5). As this data cannot be transferred via the asynchronous interface as it appears on the data bus, it is buffered in the data buffer & sync control FSM1 and, depending on cycle type, transferred in parallel and/or sequentially via the different buses to sync control FSM2. The circuit can be configured here such that during the transmission of a burst write cycle the last data word experiences no more severe overall delay than the 3-4 clock pulse initial delay by which all the data has to be kept stable at the interface.

Both FSM1 then generate the cycle_start signal in clock-controlled synchronism, but independently of each other; the master signal is synchronized and starts the two FSM2 centrally. The cycle type is notified to the FSM2 non centrally in the first transmission clock pulse in the control bus. After the FSM2 have then been started synchronously in their clock domain, they continue operating autonomously and accept data from their partner FSM1 in each clock pulse until the cycle is completed.

1. A method for the transmission of data via an asynchronous interface between a first clock domain and a second clock domain in a circuit arrangement with master/checker redundancy, comprising:
subdividing the data to be transferred into discrete data portions;
defining the start of a data portion to be transferred
defining the end of a data portion to be transferred
defining the sequence of different transmission cycles; and
handling the data transfer by Finite State Machines arranged on both sides of the interface.

2. The method according to claim 1, wherein duplicated Finite State Machines are located on both sides of the interface.

3. The method according to claim 2, wherein the duplicated Finite State Machines on a receiving side of the interface are started synchronously.

4. The method according to claim 1, wherein the data transfer is performed in different transmission cycles according to the type and volume of the data to be transferred.

5. The method according to claim 1, wherein the Finite States Machine controls the transfer on a plurality of data buses.

6. The method according to claim 2, wherein the data transfer is performed in different transmission cycles according to a type and volume of the data to be transferred.

7. The method according to claim 3, wherein the data transfer is performed in different transmission cycles according to a type and volume of the data to be transferred.

8. The method according to claim 2, wherein the Finite States Machine controls the transfer on a plurality of data buses.

9. The method according to claim 3, wherein the Finite States Machine controls the transfer on a plurality of data buses.

10. The method according to claim 4, wherein the Finite States Machine controls the transfer on a plurality of data buses.
